(19) United States
(12) Patent Application Publication
(10) Pub. No.: US 2004/0173426 A1
(43) Pub. Date: Sep. 9, 2004

(54) Vibration damping configuration

(76) Inventor: Athanasios Athanasiou, Giengen (DE)

Correspondence Address: LERNER AND GREENBERG, P.A., POST OFFICE BOX 2480, HOLLYWOOD, FL, 33022-2480, US

(21) Appl. No.: 10/801,959

(22) Filed: Mar. 15, 2004

Related U.S. Application Data
(63) Continuation of application No. PCT/EP02/10144, filed on Sep. 10, 2002.

(30) Foreign Application Priority Data
Sep. 13, 2001 (DE) 101 45 145.8

(51) Int. Cl. F16F 7/10

(52) U.S. Cl. 188/378

(57) ABSTRACT

An assembly of a vibration-generating unit and a housing accommodating the unit includes a vibration damper. The unit is retained on the housing by way of at least one dampened spring configuration that is linked with the unit on the one hand and the housing on the other hand, each at a respective connecting point. The spring configuration has at least one single spring element that is capable of oscillating with a resonant frequency different from that of the single spring element.

### CROSS-REFERENCE TO RELATED APPLICATION

This application is a continuation, under 35 U.S.C. § 120, of copending international application No. PCT/EP02/10144, filed Sep. 10, 2002, which designated the United States; this application also claims the priority, under 35 U.S.C. § 119, of German patent application No. 101 45 145.8, filed Sep. 13, 2001; the prior applications are herewith incorporated by reference in their entirety.

### BACKGROUND OF THE INVENTION

### Field of the Invention

The present invention relates to a vibration damping configuration in a system with a vibration-generating unit and a housing for holding the unit.

For the purposes of the present invention, a unit may be any desired power machine, in particular an electric motor or possibly an apparatus which is driven by it and is thought to produce undesirable vibration as a result of the operation of the power machine. A unit such as this is frequently accommodated for its own protection or for protection of the users in a housing which can itself oscillate or can be stimulated by the oscillations of the unit and furthers the undesirable noise generation by the unit.

The problem of preventing or reducing undesirable sound emission from a unit such as this and/or from its housing is very old, and a large number of approaches have been adopted in order to solve the problem.

For example, it is known for the connection between the housing and the unit, by means of which it is held on the housing, not to be designed to be rigid, but to provide spring systems between the unit and the housing, which allow the unit to oscillate with a relatively large amplitude without the amplitude being transmitted completely to the housing, where it would be emitted as sound. However, since oscillation forces are transmitted, even if to a reduced extent, from the unit to the housing with a suspension system such as that, it is never entirely possible to prevent the housing from being caused to vibrate.

Another widely used approach is to surround a vibrating unit with layers composed of silencing material. These layers are admittedly effective against sound transmitted through the air, but the transmission of structure-borne sound from a unit to its housing can be prevented only to a limited extent.

One novel approach which has been adopted relatively recently is electronic noise suppression, in which the noise signal to be suppressed is sampled and a noise with the same amplitude but with the opposite phase is produced via a loudspeaker and is destructively superimposed on the noise to be suppressed. However, this method is effective only in the far field, that is to say at a distance from the noise source where, to a good approximation, this noise source can be assumed to be a point source, and the distance between it and the loudspeaker can be ignored. In the near field, where these approximations are not valid, there is virtually no point in using the method since in fact it allows noise to be cancelled out locally in some cases, but at other points the noise to be suppressed and the noise from the loudspeaker are constructively superimposed on one another.

### SUMMARY OF THE INVENTION

It is accordingly an object of the invention to provide a vibration damping system, which overcomes the above-mentioned disadvantages of the heretofore-known devices and methods of this general type and which provides for a vibration-generating unit and a housing in which the sound emission through the housing is minimized by way of a novel effective principle.

With the foregoing and other objects in view there is provided, in accordance with the invention, an assembly comprising a housing and a vibration-generating unit mounted to said housing. The assembly further comprises:

a damped spring configuration mounting said unit to said housing and connecting at least one connecting point of said unit to a connecting point of said housing;

said spring configuration having at least one individual spring element and at least one additional oscillation-enabled element configured to oscillate at a different resonant frequency that said individual spring element.

The dissipation of vibration or oscillation energy which is injected into the arrangement from the vibration-generating unit also occurs in conventional assemblies in which, for example, rubber buffers are provided as spring configurations between the unit and the housing. These admittedly convert a small proportion of the injected vibration or oscillation energy to friction heat and thus dissipate it, but are well away from achieving the dissipation power which can be achieved according to the present invention by the spring configuration having an internal degree of oscillation freedom. This allows oscillation movement in the interior of the spring configuration, with an amplitude which may assume relatively high values in comparison to the amplitude of the coupling points to the unit or to the housing at the ends of the spring configuration. It is obvious that major internal movements of the spring dissipate considerably more vibration or oscillation energy into heat than in the case with conventional spring configurations which have no such internal degree of freedom. This dissipated energy can no longer be emitted as a noise from the unit or from the housing.

This degree of freedom is preferably created by the spring configuration being formed from two or more individual spring elements which are connected in series between the unit and the housing. The junction point between the individual spring elements can thus oscillate with a degree of freedom of their own.

In order to make it possible to stimulate this degree of freedom effectively it is expedient for the individual spring elements to have different spring constants.

In order to achieve a high dissipation power, the oscillation amplitude of the internal degree of freedom must not be excessively low since, if it were to be zero, the dissipation would also be zero. In order that the amplitude of the internal degree of freedom is not excessively low, it must be able to store a suitable amount of oscillation energy; for this purpose, it is expedient to suspend a mass which can oscillate between each of the individual spring elements.

The oscillation of the internal degree of freedom can be described by an expression in the form x=e^{-αt}, where x is the deflection, t is the time and α is a complex constant which is determined in a manner known per se by the spring constant and the damping of the internal degree of freedom. The damping should preferably be only sufficiently strong that |Re α|<10 |Im α|. In order on the other hand to ensure damping propagation of the internal resonance, which also makes it possible to stimulate this by means of injected oscillations which are not matched precisely to its resonant frequency, the damping should be at least sufficiently strong that |Re α|<0.1 |Im α|.

In general, a unit is mounted in a housing at two or more suspension points, with spring configurations with an internal degree of freedom between the unit and the housing expediently being provided at all of these suspension points.

Masses, which can oscillate, of these two or more spring configurations may be connected to one another in order to maintain as high a degree of symmetry as possible for the entire system which can oscillate, and in order to avoid a chaotic oscillation response, in which the intensity of the various spectral components of the emitted noise varies with time.

The configuration according to the invention is preferably a refrigerator and the unit is preferably a compressor for this refrigerator.

Other features which are considered as characteristic for the invention are set forth in the appended claims.

Although the invention is illustrated and described herein as embodied in a vibration damping configuration, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic of a spring configuration according to the fundamental principle of the invention;

FIG. 2 is a graph plotting the damping response of a spring configuration according to the invention, in comparison with damping by way of an individual spring;

FIG. 3 is a diagrammatic section through a refrigerator, as an example of a system of the unit and housing according to the invention;

FIG. 4 is a perspective view of a spring configuration in the refrigerator shown in FIG. 2; and

FIG. 5A is a plan view onto a first exemplary embodiment of a support configuration for the compressor of the refrigerator;

FIG. 5B is a side elevational view thereof;

FIG. 5C is a plan view of an alternative embodiment of the configuration; and

FIG. 5D is a plan view onto an further alternative embodiment of the invention.

### DESCRIPTION OF THE PREFERRED EMBODIMENTS

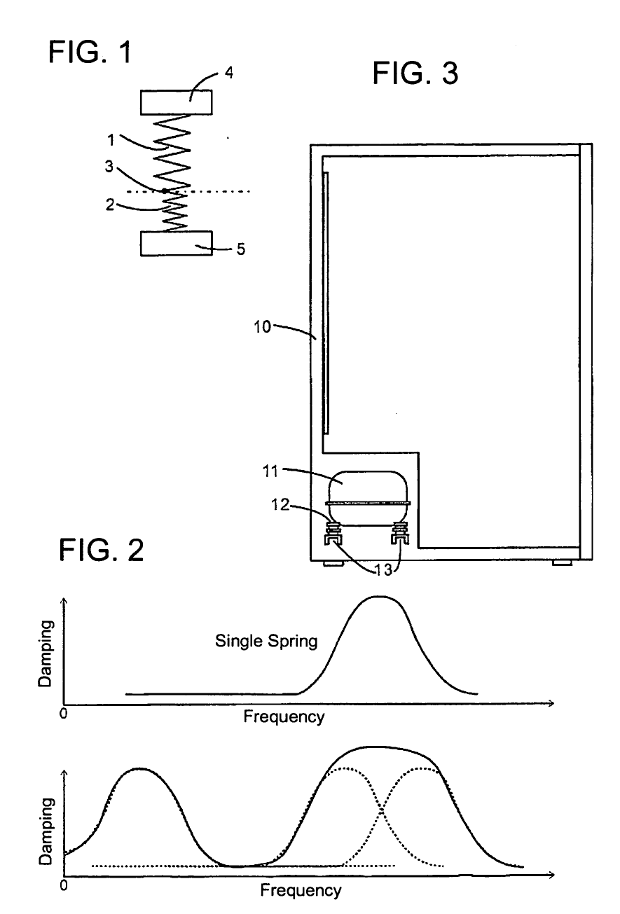

Referring now to the figures of the drawing in detail and first, particularly, to FIG. 1 thereof, there is shown an idealized illustration of a spring configuration for a system with a vibration-generating unit and a housing. The spring configuration is formed from two individual spring elements 1, 2, which are illustrated here as helical springs. It will be understood that, in principle, the spring elements 1 may be springs of any desired type. Particularly suitable are solid bodies composed of a highly dissipating, rubber-elastic material. The springs are connected to one another at a point 3 and, at their ends remote from the point 3, they are connected to a respective body 4 or 5, one of which represents the vibration-generating unit and the other represents the housing. For the purposes of the present description, it shall be assumed that 4 is the unit and 5 is the housing.

The individual spring elements 1, 2 have mutually different spring constants k1, k2. The two spring constants are superimposed, according to the principle of springs in series, to form an equivalent spring constant or overall spring constant

$$K = \frac{1}{\frac{1}{{k}_{1}} + \frac{1}{{k}_{2}}} = \frac{{k}_{1} {k}_{2}}{{k}_{1} + {k}_{2}}$$

which determines the oscillation response of the unit and housing with respect to one another.

Each of the individual spring elements 1, 2 can intrinsically oscillate at an actual frequency which is governed by its spring constant and its mass. If vibration is injected from the unit 4 into the spring configuration, then this leads to stimulation of natural oscillations of the springs 1, 2. Since these are coupled, the spring configuration can oscillate not only at the frequency which is governed by the overall spring constant K but, furthermore, at the natural frequencies of the springs 1 and 2 as well as at their sum and difference frequencies.

The natural frequencies of the springs 1, 2 are expediently in the upper audible spectral range, but they may also be higher than this since the resonances are broadened widely by damping. An individual spring can thus provide effective damping in its resonant spectral range; below this range, it is only slightly effective, as is shown in an idealized form in the upper part of FIG. 2. The spring configuration according to the present invention, on the other hand, damps a considerably broader spectral range, which is composed of the resonant spectral ranges of the two individual springs and, in addition, the difference frequency spectral range, as is shown in the lower part of FIG. 2, where dashed lines are in each case used to show the contribution of the individual springs and the difference frequency for damping, and a solid line is used to illustrate the overall damping of the system.

That component of the movement of the unit 4 which stimulates one of the two or more oscillations of the spring configuration and resonance is broken down by dissipation within the spring configuration, so that it no longer reaches the housing 5 and can no longer stimulate noisy vibration on the housing 5.

FIG. 3 shows a second refinement of the invention, applied to a refrigerator. One major source of noise in household refrigerators are the compressors used in them, and the electric drive motors which are used in the compressors. These can cause the capsule that surrounds the compressor to oscillate at a large number of different frequencies, and the object is to limit the transmission of these frequencies to the housing of the refrigerator.

The capsule of the compressor 11 which is arranged in a lower corner of the housing 10 conventionally has a number of lugs 12 which are used for attachment to mounting rails 13 in the housing.

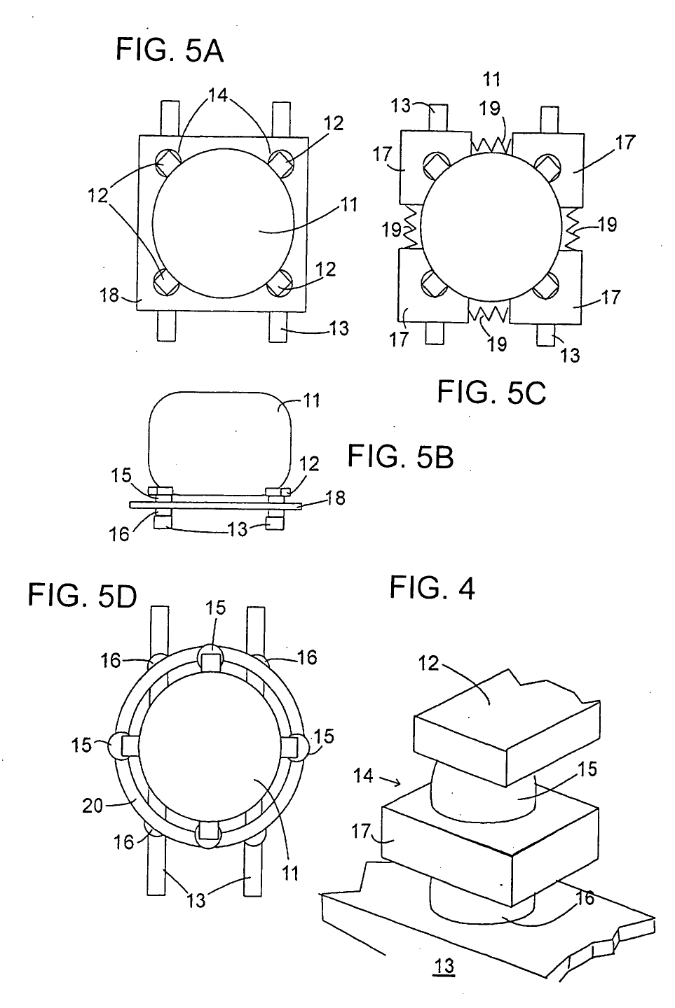

FIG. 4 shows a perspective view of one such lug 12 and of the spring configuration 14 which is located between it and the mounting rail 13. The spring configuration 14 is composed of two individual spring elements 15, 16 in the manner of rubber buffers, between which a free mass or an inertia body 17 is arranged. The inertia body 17 acts as an energy store for the various degrees of oscillation freedom of the spring configuration and improves the effectiveness with which the natural oscillations of the spring configuration are stimulated by an externally injected oscillation.

This mass may expediently be chosen such that the oscillation frequency of the inertia body 17 is in the oscillation range in which the compressor capsule is stimulated by the motor and it is intended to be damped. The resonant frequency of the resonator that is formed from the spring elements 15, 16 and the inertia body 17 is

$$ν = \frac{1}{2 π} \sqrt{\frac{K}{m}} ,$$

where m is an equivalent mass which is composed of the mass of the inertia body 17 and contributions from the spring elements 15, 16. Since the spring elements 15, 16 are composed of a highly damping material, the Q-factor of this resonator is extremely low, so that the inertia body 17 can be stimulated to oscillate in a very wide frequency band around its resonant frequency ν. With this refinement, there is no need for the natural frequencies of the spring elements 15, 16 to be different in order to make it possible to stimulate the oscillation of the inertia body 17.

It should also be noted that the spring configuration shown in FIG. 4 can oscillate not only in a single direction, for example longitudinally along its axis, but also transversely with respect to this axis, and the various movement directions may also each have different spring constants.

All this means that there is no need for complex computational optimization in order to achieve effective vibration damping with the illustrated spring configuration. As soon as the natural frequency—or one of the natural frequencies if the different possible movement directions are considered—of the inertia body 17 is approximately of the same order of magnitude as the oscillations of the compressor 11 to be damped, the spring configuration 14 effectively damps the transmission of these oscillations to the housing 10.

Various modifications of the spring configuration 14 are possible. For example, the inertia body 17 need not be a rigid body, as assumed above, but may also itself in turn represent a spring element, so that the spring configuration 14 overall comprises three spring elements connected in series.

Another possibility is to provide a series arrangement with more than one inertia body 17, for example a series arrangement comprising three spring elements which are each separated by an inertia body, in order in this way to damp the oscillation fed in from the compressor 11 in two successive steps. In this case, different masses may be provided for each of the two inertia bodies and/or different spring constants may be provided for the springs surrounding them in order to produce different natural frequencies for the inertia bodies by effective damping in different frequency ranges.

A further modification of the invention is illustrated in the plan view of FIG. 5A and the side elevation of FIG. 5B.

Conventionally and as shown in the plan view of FIG. 5A, the housing of the compressor 11 is provided with four lugs 12. A spring configuration 14 for connection to the mounting rails 13 of the housing is disposed on each of these lugs 12. The inertia bodies 17 of the spring configurations 14 are in this case fused to a single plate 18, which is clamped in at each of the four points between the spring elements 15, 16 of the four spring configurations 14.

This fusion results in the compressor 11 being suspended in a more robust manner in the housing 10 than in the case of four independent inertia bodies.

In the exemplary embodiment illustrated in FIG. 5C, only a plan view of which is shown, the four inertia bodies 17 are connected to one another by springs 19, and can thus oscillate with respect to one another. This also makes it possible to use the dissipation capability of the springs 19 for absorption of vibration energy.

In the variant shown in FIG. 5D, the inertia bodies of the four spring configurations are fused to form a ring 20, and the spring elements 15 and 16 each act at different points on the ring. An arrangement such as this furthers the stimulation of bending oscillations in the ring 20, and is particularly useful when the ring itself is composed of a vibration-damping material.

I claim:

1. An assembly, comprising:
a housing;
a vibration-generating unit mounted to said housing;
a damped spring configuration mounting said unit to said housing and connecting at least one connecting point of said unit to a connecting point of said housing;
said spring configuration having at least one individual spring element and at least one additional oscillation-enabled element configured to oscillate at a different resonant frequency that said individual spring element.

2. The assembly according to claim 1, wherein said additional element is a further individual spring element.

3. The assembly according to claim 1, wherein said additional element is an oscillation-enabled mass.

4. The assembly according to claim 1, wherein said individual spring element is one of a plurality of individual spring elements connected in series between said unit and said housing.

5. The assembly according to claims 3, wherein said individual spring element is one of a plurality of individual spring elements and said mass is suspended between individual spring elements of said spring configuration.

6. The assembly according to claim 5, wherein said spring configuration is one of a plurality of spring configurations each including a respective said oscillation-enabled mass, and wherein said masses of different said spring configurations are connected to one another.

7. The assembly according to claim 2, wherein said individual spring elements have mutually different spring constants.

8. The assembly according to claim 1, wherein the resonant frequencies have a difference frequency in an audible spectral range.

9. The assembly according to claim 1, wherein a free oscillation of said additional element is described by an expression in the form x=e^{-αt}, where x is a deflection, t is the time, and α is a complex parameter, where 0.1 |Re α|<|Im α|<10 |Reα|.

10. The assembly according to claim 2, wherein said individual spring elements are bodies composed of an elastically deformable material.

11. The assembly according to claim 1 in a refrigerator, wherein said unit is a compressor and said housing is a refrigerator housing.

12. In an assembly having a vibration generator and a housing, an assembly for reducing a vibration transfer from said vibration generator to said housing, comprising:
a damped spring configuration mounting at least one connecting point of the vibration generator to a connecting point of said housing;
said spring configuration including an individual spring element having a given resonant frequency and an oscillation-enabled element having a given resonant frequency different the resonant frequency of said individual spring element.

13. The assembly according to claim 12, wherein said oscillation-enabled element is a further individual spring element.

14. The assembly according to claim 12, wherein said oscillation-enabled element is an oscillation-enabled mass.
